(19) United States
(12) Patent Application Publication
(10) Pub. No.: US 2015/0077515 A1
(43) Pub. Date: Mar. 19, 2015

(54) METHOD AND DEVICE FOR COMPENSATING FOR SYNCHRONIZATION BETWEEN LEFT AND RIGHT IMAGE FRAMES IN THREE-DIMENSIONAL IMAGING SYSTEM, AND REPRODUCTION DEVICE AND METHOD

(71) Applicant: Electronics and Telecommunications Research Institute, Daejeon (KR)

(72) Inventors: Gwang Soon Lee, Daejeon (KR); Eung Don Lee, Daejeon (KR); Chan Kim, Daejeon (KR); Jin Hwan Lee, Daejeon (KR); Hyun Lee, Daejeon (KR); Won Sik Cheong, Daejeon (KR); Nam Ho Hur, Daejeon (KR)

(21) Appl. No.: 14/394,988

(22) PCT Filed: Apr. 17, 2013
(86) PCT No.: PCT/KR2013/003229

§ 371 Date: Oct. 16, 2014

(30) Foreign Application Priority Data
Apr. 17, 2012 (KR) 10-2012-0039995
Apr. 17, 2013 (KR) 10-2013-0042027

(51) Int. Cl. H04N 13/00

(52) U.S. Cl. CPC H04N 13/0051; H04N 13/0048; H04N 13/0059
USPC 348/43

(57) ABSTRACT

An apparatus for compensating for synchronization between left and right image frames in a stereoscopic system includes a similarity calculating unit configured to calculate similarity between left and right image frames on the basis of a scene change point in time of the left and right image frames, a left and right image frame difference value extracting unit configured to search a stereoscopic pair on the basis of the similarity and extract a temporal frame difference value between the left and right image frames, and a left and right image frame synchronization compensating unit configured to perform synchronization by shifting any one of the the left and right image frames on a time axis on the basis of the left and right image frame difference value.

### BACKGROUND OF THE INVENTION

1. Field of the Invention

The present invention relates to a method and apparatus for to compensating for synchronization in a stereoscopic system and, more particularly, to a method and apparatus for checking temporal synchronization between left and right image frames of a stereoscopic image and compensating for synchronization by left and right image frames if necessary.

2. Related Art

When a person views an image through his or her eyes, the left and right eyes view different images, and by using the mutually different visual information, the person recognizes a distance and feels a stereoscopic sense. Based on this principle, a stereoscopic image is directly captured by using a stereoscopic camera, or images to be viewed to the left and right eyes of a person are obtained through computer graphics, combined, and provided to the two eyes of the person to allow the person feel a stereoscopic sense. In this case, if images, which are not temporally synchronized, are viewed to the left and right eyes, the person cannot properly feel stereoscopic sense through the stereoscopic image thereof. Thus, a process of automatically checking whether the left and right image frames are properly synchronized, obtaining information regarding a time difference between the corresponding 3D images when left and right image frames are not temporally synchronized, and correcting them is required.

The case in which left and right image frames are not properly synchronized, namely, the case in which left and right stereoscopic pairs when originally generated are disposed to deviate from each other temporally, may take place while a stereoscopic image is captured, stored, distributed, transmitted, and reproduced. This case may occur occasionally, so a user directly check whether left and right images are a proper stereoscopic pair and directly edit and correct to the same in a tool for generating and editing numerous stereoscopic images or in a stereoscopic image display. However, in order to check temporal coincidence between left and right images, in the related art, a user merely directly checks with his or her eyes a stereoscopic image being played in a 3D display and checks whether left and right image frames are synchronized according to whether there is a 3D effect and whether an image is awkward. In this case, although the user directly checks s stereoscopic image, determination on the presence or absence of a 3D effect or awkwardness of the image are subjective, so, in a situation, it may be difficult to determine whether images are properly disposed according to users.

Thus, a method and apparatus for checking whether left and right image frames are properly synchronized by using features appearing in a 3D image properly synchronized when originally generated, and automatically changing them when the left and right image frames are not properly synchronized are required.

### SUMMARY OF THE INVENTION

The present invention provides a method and apparatus for compensating for synchronization between left and right image frames in a stereoscopic system, wherein scene change points in time are discovered from left and right images, similarity between the scene change points in time is recognized to check whether left and right image frames are synchronized, and when left and right image frames are not properly synchronized, to which degree the left and right image frames deviate temporally, namely, how much differently temporally 3D stereoscopic pair are disposed in an image sequence, is automatically calculated, to and the improper synchronization is compensated if necessary, and rendering apparatus and method.

In an aspect, an apparatus for compensating for synchronization between left and right image frames in a stereoscopic system includes: a similarity calculating unit configured to calculate similarity between left and right image is frames on the basis of a scene change point in time of the left and right image frames; a left and right image frame difference value extracting unit configured to search a stereoscopic pair on the basis of the similarity and extract a temporal frame difference value between the left and right image frames; and a left and right image frame synchronization compensating unit configured to perform synchronization by shifting any one of the left and right image frames on a time axis on the basis of the left and right image frame difference value.

The apparatus may further include: a scene change tine point detecting unit configured to detect a scene change point in time with respect to a left image and a right image.

The scene change time point detecting unit may detect a scene change point in time by using a change in any one of brightness, color, and complexity of preceding and subsequent frames.

The similarity calculating unit may measure similarity by using any one of brightness, color, and complexity of the left image frame and the right image frame related to a scene change point in time.

The similarity calculating unit may measure similarity between preceding or subsequent frames of a plurality of scene change points in time of the left image and the right image.

The similarity calculating unit may measure similarity between a plurality to of frames with respect to a plurality of scene change points in time detected for a predetermined time in order to increase accuracy of similarity calculation.

The left and right image frame difference value extracting unit may include: a stereoscopic pair determining unit configured to compare similarity between the left image frame and the right image frame related to the scene is change point in time to determine a stereoscopic pair; and a difference value calculating unit configured to calculate a temporal frame difference value between a left image frame and a right image frame determined as the stereoscopic pair.

The apparatus may further include: an encoding unit configured to encode the left and right image frames to generate a bit stream; and a transmitting unit configured to transmit the encoded bit stream to a receiver.

Time information of the encoded bit stream may be corrected as much as being shifted based on the left and right image frame difference value.

In another aspect, a method for compensating for synchronization between left and right images in a stereoscopic system, includes: a similarity calculation operation of calculating similarity between left and right image frames on the basis of a scene change point in time of the left and right image frames; a left and right image frame difference value extraction operation of searching a stereoscopic pair on the basis of the similarity and extracting a temporal frame difference value between the left and right image frames; and a left and right image frame synchronization compensation operation of performing synchronization by shifting one of the left and right image frames in a time axis on the basis of the left and right frame difference value.

In another aspect, an apparatus for compensating for synchronization between left and right images to render left and right images in a stereoscopic system, includes: a receiving unit configured to receive a bit stream; a demultiplexing unit configured to demultiplex the received bit stream to generate left and right image frames; a similarity calculating unit configured to calculate similarity of the left and right image frames on the basis of a scene change point in time of the generated left and right image frames; a left and right image frame difference value extracting unit configured to search a stereoscopic pair on the basis of the similarity and extract a temporal frame difference value between the left and right image frames; a left and right image frame synchronization compensating unit configured to perform synchronization by shifting one of left and right images in a time axis on the basis of the left and right image frame difference value; and a rendering unit configured to render the synchronized left and right image frames.

The apparatus may further include: a scene change tine point detecting unit configured to detect a scene change point in time with respect to a left image and a right image.

The scene change time point detecting unit may detect a scene change point in time by using a change in any one of brightness, color, and complexity of preceding and subsequent frames.

The similarity calculating unit may measure similarity by using any one of brightness, color, and complexity of the left image frame and the right image frame related to a scene change point in time.

The similarity calculating unit may measure similarity between preceding or subsequent frames of a plurality of scene change points in time of the left image and the right image.

The similarity calculating unit may measure similarity between a plurality of frames with respect to a plurality of scene change points in time detected for a predetermined time in order to increase accuracy of similarity calculation.

The left and right image frame difference value extracting unit may include: a stereoscopic pair determining unit configured to compare similarity between the left image frame and the right image frame related to the scene change point in time to determine a stereoscopic pair; and a difference value calculating unit configured to calculate a temporal frame difference value between a left image frame and a right image frame determined as the stereoscopic pair.

In another aspect, a method for compensating for synchronization between left and right images to render left and right images in a stereoscopic system, includes: a reception operation of receiving a bit stream; a demultiplexing operation of demultiplexing the received bit stream to generate left and right image frames; a similarity calculation operation of calculating similarity of the left and right image frames on the basis of a scene change point in time of the generated left and right image frames; a left and right image frame difference value extraction operation of searching a stereoscopic pair on the basis of the similarity and extracting a temporal frame difference value between the left and right image frames; a left and right image frame synchronization compensation operation of performing synchronization by shifting one of left and right images in a time axis on the basis of the left and right image frame difference value; and a rendering operation of rendering the synchronized left and right image frames.

According to the method and apparatus for compensating for synchronization between left and right image frames and the rendering apparatus and method in a stereoscopic system, a temporal difference between left and right image frames and corrected as necessary, thus resolving user inconvenience as in the related art in which a user should directly check with his eyes to compensate for synchronization, and transmitting proper 3D expression when a user views 3D images. Also, in case of a software module, the present invention can be applicable to an editing tool, a stereoscopic video player, and the like, to significantly assist in editing and rendering a stereoscopic image.

### BRIEF DESCRIPTION OF THE DRAWINGS

FIG. 1 is a block diagram schematically illustrating a configuration of an apparatus for compensating for synchronization between left and right images in a stereoscopic system according to an embodiment of the present invention;

FIG. 2 is a conceptual view illustrating calculation of similarity between left and right image frames on the basis of a scene change point in time by a similarity calculating unit of the apparatus for compensating for synchronization between left and right images in a stereoscopic system according to an embodiment of the present invention;

FIG. 3 is a conceptual view illustrating calculation of similarity based on a plurality of frames by the similarity calculating unit of the apparatus for compensating for synchronization between left and right images in a stereoscopic system according to an embodiment of the present invention;

FIG. 4 is a detailed block diagram illustrating a inter-left right image frame difference value extracting unit of the apparatus for compensating for synchronization between left and right images in a stereoscopic system according to an embodiment of the present invention;

FIG. 5 is a block diagram illustrating a configuration of the apparatus for compensating for synchronization between left and right images in a stereoscopic system further including an encoding unit and a transmitting unit according to an embodiment of the present invention;

FIG. 6 is a block diagram schematically illustrating a configuration of a rendering apparatus according to compensation for left and right image synchronization in a stereoscopic system according to an embodiment of the present invention;

FIG. 7 is a block diagram schematically illustrating a method for compensating for synchronization between left and right images in a stereoscopic system according to an embodiment of the present invention.

### DESCRIPTION OF EXEMPLARY EMBODIMENTS

The present invention may be embodied in many different forms and may have various embodiments, of which particular ones will be illustrated in drawings and will be described in detail.

However, it should be understood that the following exemplifying description of the invention is not meant to restrict the invention to specific forms of the present invention but rather the present invention is meant to cover all modifications, similarities and alternatives which are included in the spirit and scope of the present invention.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. In addition, unless explicitly described to the contrary, the word “comprise” and variations such as “comprises” or “comprising,” will be understood to imply the inclusion of stated elements but not the exclusion of any other elements.

Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

Embodiments of the present invention will be described below in detail with reference to the accompanying drawings, where those components are rendered the same reference number that are the same or are in correspondence, regardless of the figure number, and redundant explanations are omitted.

In order to find temporally deviating stereoscopic pair, an apparatus for compensating for synchronization between left and right images in a stereoscopic system according to an embodiment of the present invention may use the following algorithm. In this case, an algorithm in which scenes of a screen are changed left and right at the same time and similarity between left and right images in the same scene is higher is used. Namely, in a stereoscopic image, a binocular parallax exists between left and right images of a stereoscopic image, but since the same scene is imaged, points in time at which scenes are changed will be the same. If a plurality of scenes are changed within a predetermined time, similarity between left and right images the instant that scenes are changed is calculated to finally find out a stereoscopic pair. This uses the characteristics that when left and right images are positioned in the same scene section, respectively, they have a similar image distribution, relative to a case in which left and right images are positioned in different scene sections, respectively. Also, in the present disclosure, left and right images are used as a reference, but in a case in which a plurality of stereoscopic image frames are provided, the present invention may also be applicable to a relationship between a left image and a middle image or a relationship between a middle image and a right image.

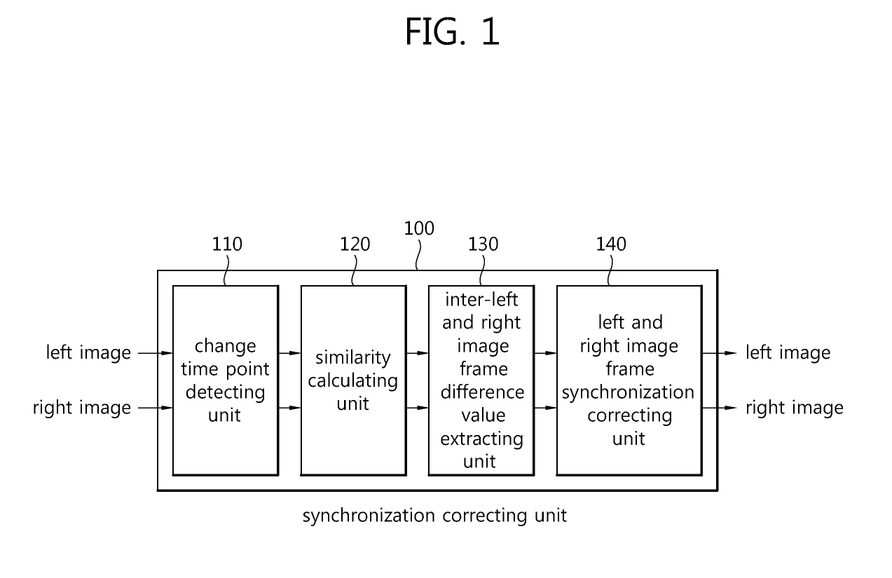

FIG. 1 is a block diagram schematically illustrating a configuration of an apparatus for compensating for synchronization between left and right images in a stereoscopic system according to an embodiment of the present invention. As illustrated in FIG. 1, the apparatus for compensating for synchronization between left and right images in a stereoscopic system according to an embodiment of the present invention may include a synchronization compensating unit 100 including a change time point detecting unit 110, a similarity calculating unit 120, an inter-left and right image frame difference value extracting unit 130, and a left and right image frame synchronization compensating unit 140.

Referring to FIG. 1, the change time point detecting unit 110 receives left and right image frames and detects a scene change point in time or change instants generated for a predetermined period of time with respect to the left and right image frames. The scene change point in time may be detected by using a change in brightness, color, complexity, and the like, of continued frames, e.g., between previous and subsequent frames. For example, the change time point detecting unit 110 may compare a change in any one of the features with a predetermined threshold value to check whether it is equal to or higher than the predetermined threshold value, to thus detect whether it is a scene change point in time. In order to detect a scene change point in time, various methods other than the foregoing method may be used.

The similarity calculating unit 120 is an element required when a plurality of scene change points in time are generated for a predetermined period of time. The similarity calculating unit 120 calculates similarity between or among left and right scene change points in time in order to find a stereoscopic pair among a plurality of scene change points in time. Here, similarity between images refers to a degree at which scenes are similar, and similarity between left and right scene change points in time may be calculated by using brightness, color, complexity, and the like, of the two screens. For example, similarity between left and right scene change points in time may be calculated by using at least any one of a difference in brightness, color, and complexity of left and right image frames related to a scene change point in time. As two screens are the same, similarity therebetween may be higher.

The inter-left and right image frame difference value extracting unit 130 searches a stereoscopic pair on the basis of left and right image frames having the greatest value of similarity calculated by the similarity calculating unit 120, and extracts a temporal frame difference value between left and right images.

The left and right image frame synchronization compensating unit 140 performs synchronization by deferring one of two images by a frame difference value extracted by the inter-left and right image frame difference value extracting unit 130. Namely, the left and right image frame synchronization compensating unit 140 shifts any one of the left and right images such that a frame difference in a time axis is resolved, thus synchronizing them.

If the synchronization compensating unit 100 is used in a 3DTV re-multiplexer, 3D bit stream monitoring equipment, and the like, handling an encoded bit stream, timing information of an encoded bit stream, e.g., PCR (program clock reference), PTS (presentation time stamp), CTS (composition time stamp), and the like, may also be simultaneously compensated to correspond to the delay of one image.

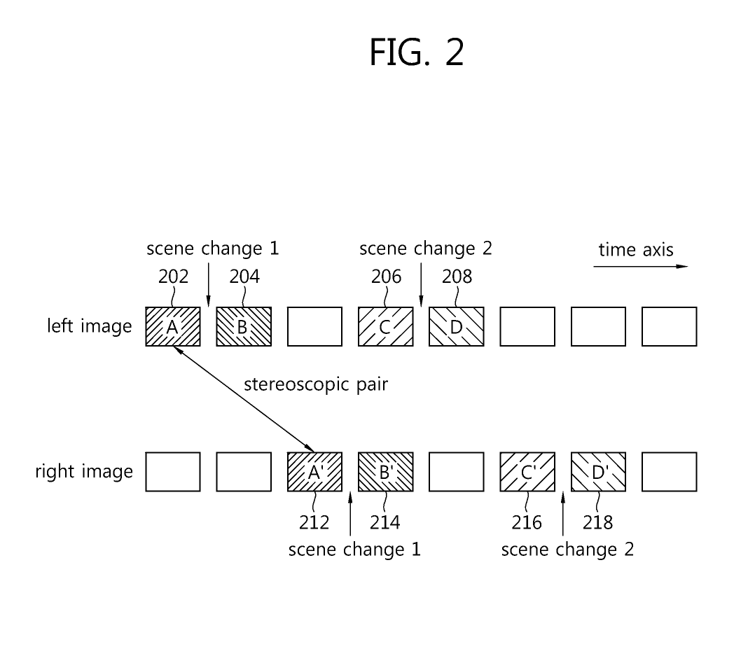

FIG. 2 is a conceptual view illustrating calculation of similarity between left and right image frames on the basis of a scene change point in time by the similarity calculating unit 120 of the apparatus for compensating for synchronization between left and right images in a stereoscopic system according to an embodiment of the present invention.

Referring to FIG. 2, a left image frame and a right image frame are placed in a time axis so as to be sequentially expressed. The similarity calculating unit 120 obtains a plurality of scene change time point information detected by the change time point detecting unit 110 (e.g., scene change 1 and scene change 2). Thereafter, in order to search a corresponding stereoscopic pair on the basis of the plurality of scene change points in time generated in left and right images for a predetermined period of time, the similarity calculating unit 120 measures similarity between image frames related to the scene change points in time. The image frames related to the scene change points in time may be preceding image frames 202, 206, 212, and 216 (A and C in the left image and A′ and C′ in the right image) before the scene change point in time or subsequent image frames 204, 208, 214, and 218 (B and D in the left image and B′ and D′ in the right image), and the similarity calculating unit 120 may measure similarity between the preceding image frames 202, 206, 212, and 2116 or between the subsequent image frames 204, 208, 214, and 218.

Here, when a plurality of change points in time exist, the similarity calculating unit 120 calculates similarity in consideration of all the number of cases between the plurality of left and right image frames before the scene change point in time. The case of using subsequent image frames is no different. For example, in case of calculating similarity by using the preceding image frames 202, 206, 212, and 216, similarity between the left image frame A 202 and the right image frames A′ 212 and C′ 216, namely, similarity between A and A′ and A and C′, are calculated, respectively. Here, when similarity between the left image frame A 202 and the right image frame A′ 212, i.e., a similarity value between A and A′, is greater than similarity between the left image frame A 202 and the right image frame C′ 216, i.e., a similarity value between A and C′, it may be determined that the left image frame A 202 and the right image frame A′ 212 are a stereoscopic pair. In this manner, similarity may be used as a determination reference for determining a stereoscopic pair.

Similarly, when similarity is calculated by using the subsequent image frames 204, 208, 214, and 218, similarity between the left image frame B 204 and the right image frames B′ 214 and D′ 218, i.e., similarity between B and B′ and B and D′, respectively.

Here, when similarity between the left image frame B 204 and the right image frame B′ 214, i.e., a similarity value between B and B′, is greater than similarity between the left image frame B 204 and the right image frame D′ 218, i.e., a similarity value between B and D′, it may be determined that the left image frame B 204 and the right image frame B′ 214 are a stereoscopic pair.

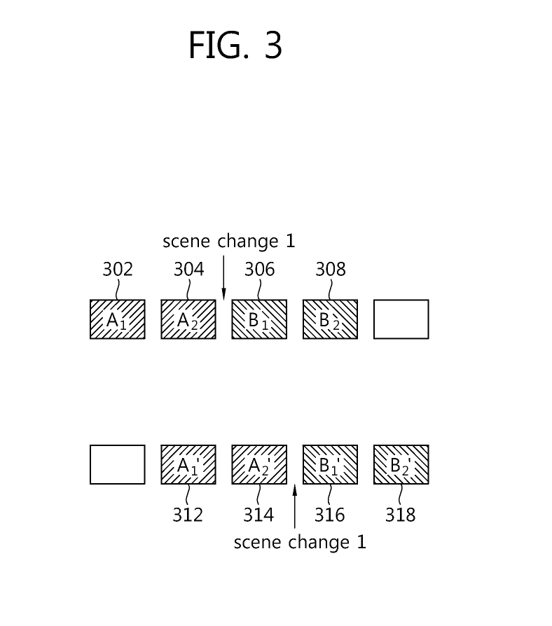

FIG. 3 is a conceptual view illustrating calculation of similarity based on a plurality of frames by the similarity calculating unit 120 of the apparatus for compensating for synchronization between left and right images in a stereoscopic system according to an embodiment of the present invention.

Referring to FIG. 3, in order to increase accuracy, the similarity calculating unit 120 may measure similarity between a plurality of frames to increase accuracy in similarity measurement. For example, a plurality of image frames 302, 304, 312 and 314 before a scene change point in time may be used. In this case, the similarity calculating unit 120 may measure similarity between the left frames A₁ 302 and A₂ 304 and right image frames A₁′ 312 and A₂′ 314, i.e., similarity between A₁ and A₁′ and A₂ and A₂′. Similarity, in case of using the plurality of image frames 306, 308, 316, and 318 after the scene change point in time, similarity between B₁ 306 and B₂ 308 and right frames B₁′ 316 and B₂′ 318, i.e., similarity between B₁ and B₁′ and B₂ and B₂′. As mentioned above, the plurality of frames are not necessarily limited to two frames and three or more frames may be compared. However, preferably, similarity may be measured by comparing an appropriate amount of frames in consideration of calculation complexity required for measuring frame similarity.

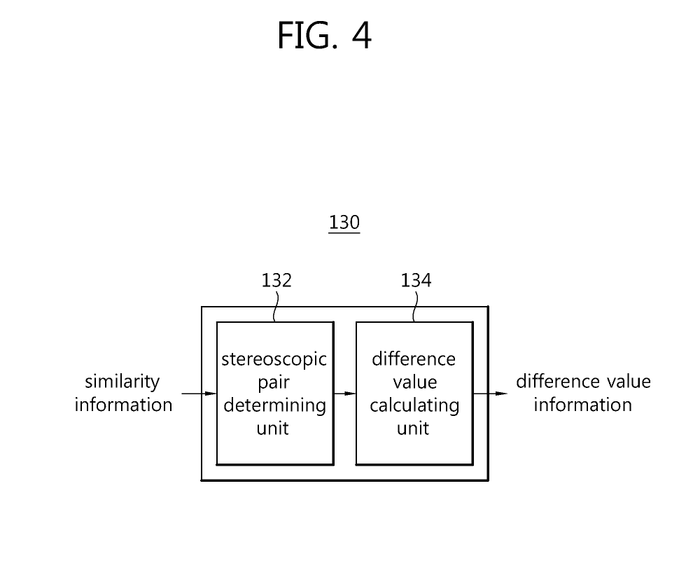

FIG. 4 is a detailed block diagram illustrating the inter-left right image frame difference value extracting unit 130 of the apparatus for compensating for synchronization between left and right images in a stereoscopic system according to an embodiment of the present invention. As illustrated in FIG. 4, the inter-left right image frame difference value extracting unit 130 may include a stereoscopic pair determining unit 32 and a difference value extracting unit 134.

Referring to FIG. 4, the stereoscopic pair determining unit 132 receives similarity information regarding respective left and right image frames from the similarity calculating unit 120. The stereoscopic pair determining unit 132 determines a stereoscopic pair on the basis of the received similarity information. Here, a left image frame and a right image frame having the highest degree of similarity may be determined as a stereoscopic pair. For example, when similarity between A and A′, among similarity between A and A′ and similarity between A and C′, is higher, the left image frame A and the right image frame A′ may be determined as a stereoscopic pair.

The difference value extracting unit 134 calculates a difference between frames on the basis of the determined stereoscopic pair. Namely, when A and A′, are not in the same line in a time axis and A is ahead of A′ by two frames, a frame difference value may be 2. The information regarding the frame difference value is transmitted to the left and right image frame synchronization compensating unit 140, and the left and right image frame synchronization compensating unit 140 compensates for synchronization by shifting any one of the left and right images in the time axis by the difference value.

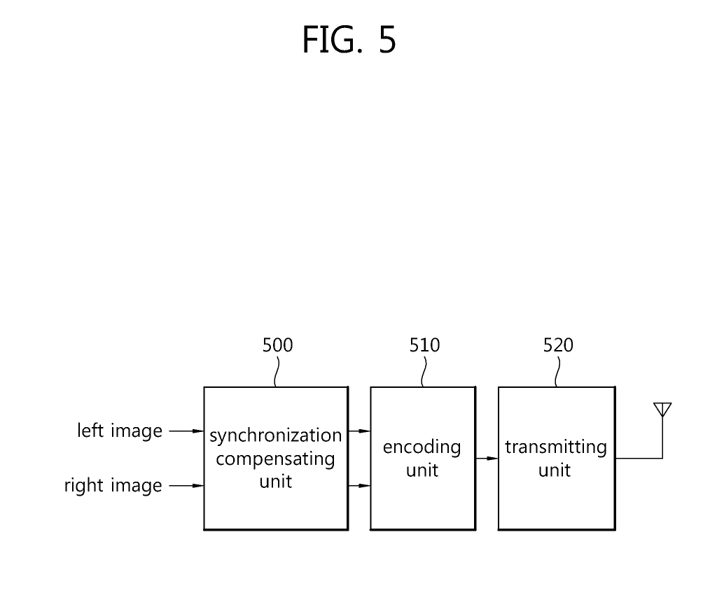

FIG. 5 is a block diagram illustrating a configuration of the apparatus for compensating for synchronization between left and right images in a stereoscopic system further including an encoding unit 510 and a transmitting unit 520 according to an embodiment of the present invention. As illustrated in FIG. 5, the apparatus for compensating for synchronization may further include a synchronization compensating unit 500, an encoding unit 510, and a transmitting unit 520.

Referring to FIG. 5, the synchronization compensating unit 500 measures similarity of frames related to a scene change point in time of left and right images, searches a stereoscopic pair on the basis of the measured similarity to calculate a temporal frame difference value, and shifts one image in a time axis on the basis of the difference value, thus compensating for synchronization between the left and right image frames.

The encoding unit 510 encodes a left image frame and a right image frame to generate an encoded bit stream. Here, timing information, e.g., a PCR (program clock reference), a PTS (presentation time stamp), a CTS (composition time stamp), and the like, of the encoded bit stream are required to be compensated simultaneously.

The transmitting unit 520 transmits the encoded bit stream to a receiver.

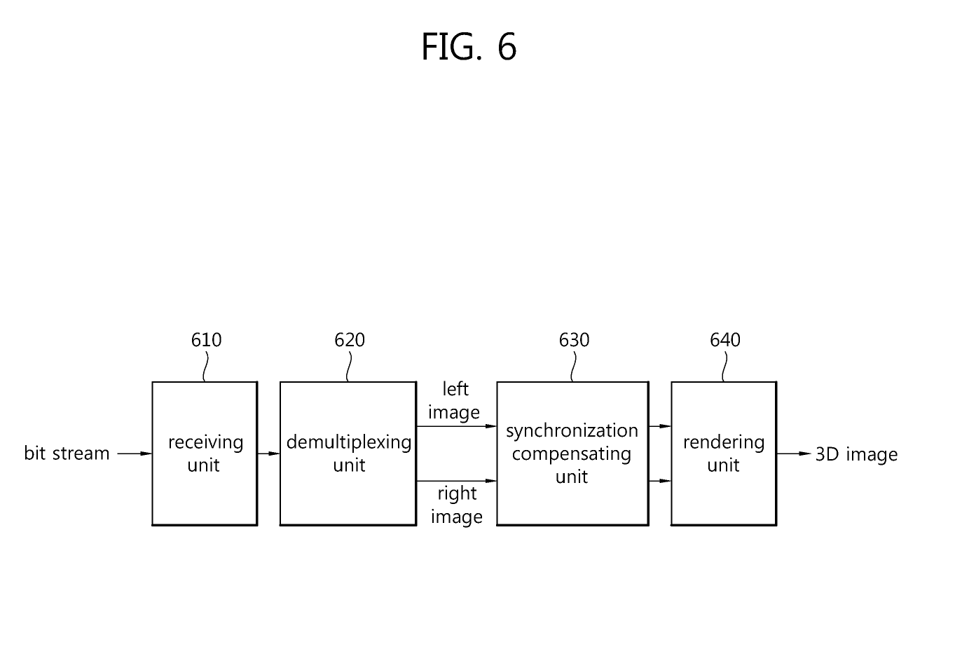

FIG. 6 is a block diagram schematically illustrating a configuration of a rendering apparatus according to compensation for left and right image synchronization in a stereoscopic system according to an embodiment of the present invention. As illustrated in FIG. 6, the rendering apparatus according to compensating for synchronization between left and right images according to an embodiment of the present invention may include a receiving unit 610, a demultiplexing unit 620, a synchronization compensating unit 630, and a rendering unit 640.

Referring to FIG. 6, the receiving unit 610 receives an encoded bit stream. Here, the bit stream may be received via a wired or wireless network.

The demultiplexing unit 620 demultiplexes the received bit stream to generate left and right image frames. Namely, a left image frame, a right image frame, and synchronization-related information may be generated.

Like the synchronization compensating unit 100 in FIG. 1, the synchronization compensating unit 630 measures similarity between frames related to a scene change point in time of left and right images, searches a stereoscopic pair on the basis of the measured similarity to calculate a temporal frame difference value, and shifts one image in a time-axis on the basis of the difference value, thus compensating for synchronization between the left and right image frames. When the synchronization-related information is extracted, if synchronization information is accurate, not requiring compensation, the compensating unit 630 may omit the process of measuring similarity, calculating frame difference value, and compensating for synchronization. Namely, synchronization may be compensated only when necessary.

The rendering unit 640 render a 3D image on the basis of the synchronization compensation-performed left and right image frames.

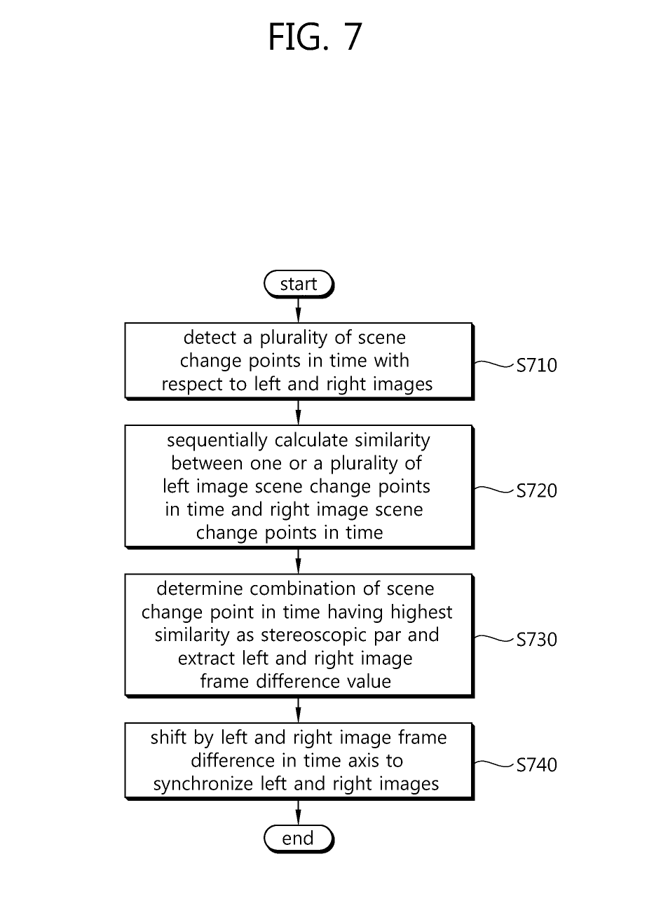

FIG. 7 is a block diagram schematically illustrating a method for compensating for synchronization between left and right images in a stereoscopic system according to an embodiment of the present invention.

Referring to FIG. 7, a left and right image synchronization compensating apparatus (not shown) extracts a plurality of scene change points in time within a predetermined time section with respect to a left image and a right image (S710). Among them, in order to search a stereoscopic pair, one or a plurality of frames related to left image scene change points in time and one or a plurality of frames related to right image scene change points in time are sequentially paired and similarity thereof is calculated, respectively (S720). The left and right image synchronization compensating apparatus (not shown) determines a pair having the highest similarity as a stereoscopic pair, and obtains a difference between frames in a certain point in time (S730). Finally, the left and right image synchronization compensating apparatus (not shown) shifts the left image or the right image by the frame difference value in the time axis to perform synchronization (S740).

The foregoing synchronization compensating method and apparatus according to the present invention may be implemented as codes that can be read by a computer in a computer-readable recording medium. The computer-readable recording medium may include any types of recording mediums in which data that can be read by a computer system is stored. For example, The computer-readable recording medium may include a ROM, a RAM, a magnetic tape, a magnetic disk, a flash memory, an optical data storage device, and the like. The computer-readable recording medium may be distributed to computer systems connected via a computer communication network and stored and executed as codes readable in a distributed fashion. Also, it may be fabricated as a chip and installed in a 3D-TV, a 3D projector, a 3D camera, a multiplier/demultiplier, a CODEC, a 3D terminal, and the like.

While the present invention has been shown and described in connection with the embodiments, it will be apparent to those skilled in the art that modifications and variations can be made without departing from the spirit and scope of the invention as defined by the appended claims.

What is claimed is:

1. An apparatus for compensating for synchronization between left and right image frames in a stereoscopic system, the apparatus comprising:
a similarity calculating unit configured to calculate similarity between left and right image frames on the basis of a scene change point in time of the left and right image frames;
a left and right image frame difference value extracting unit configured to search a stereoscopic pair on the basis of the similarity and extract a temporal frame difference value between the left and right image frames; and
a left and right image frame synchronization compensating unit configured to perform synchronization by shifting any one of the left and right image frames on a time axis on the basis of the left and right image frame difference value.

2. The apparatus of claim 1, further comprising:
a scene change tine point detecting unit configured to detect a scene change point in time with respect to a left image and a right image.

3. The apparatus of claim 2, wherein the scene change time point detecting unit detects a scene change point in time by using a change in any one of brightness, color, and complexity of preceding and subsequent frames.

4. The apparatus of claim 1, wherein the similarity calculating unit measures similarity by using any one of brightness, color, and complexity of the left image frame and the right image frame related to a scene change point in time.

5. The apparatus of claim 1, wherein the similarity calculating unit measures similarity between preceding or subsequent frames of a plurality of scene change points in time of the left image and the right image.

6. The apparatus of claim 1, wherein the similarity calculating unit measures similarity between a plurality of frames with respect to a plurality of scene change points in time detected for a predetermined time in order to increase accuracy of similarity calculation.

7. The apparatus of claim 1, wherein the left and right image frame difference value extracting unit comprises:
a stereoscopic pair determining unit configured to compare similarity between the left image frame and the right image frame related to the scene change point in time to determine a stereoscopic pair; and
a difference value calculating unit configured to calculate a temporal frame difference value between a left image frame and a right image frame determined as the stereoscopic pair.

8. The apparatus of claim 1, further comprising:
an encoding unit configured to encode the left and right image frames to generate a bit stream; and
a transmitting unit configured to transmit the encoded bit stream to a receiver.

9. The apparatus of claim 8, wherein time information of the encoded bit stream is corrected as much as being shifted based on the left and right image frame difference value.

10. A method for compensating for synchronization between left and right images in a stereoscopic system, the method comprising:
a similarity calculation operation of calculating similarity between left and right image frames on the basis of a scene change point in time of the left and right image frames;
to a left and right image frame difference value extraction operation of searching a stereoscopic pair on the basis of the similarity and extracting a temporal frame difference value between the left and right image frames; and
a left and right image frame synchronization compensation operation of performing synchronization by shifting one of the left and right image frames in a time axis on the basis of the left and right frame difference value.

11. An apparatus for compensating for synchronization between left and right images to render left and right images in a stereoscopic system, the apparatus comprising:
a receiving unit configured to receive a bit stream;
a demultiplexing unit configured to demultiplex the received bit stream to generate left and right image frames;
a similarity calculating unit configured to calculate similarity of the left and right image frames on the basis of a scene change point in time of the generated left and right image frames;
a left and right image frame difference value extracting unit configured to search a stereoscopic pair on the basis of the similarity and extract a temporal frame difference value between the left and right image frames;
a left and right image frame synchronization compensating unit configured to perform synchronization by shifting one of left and right images in a time axis on the basis of the left and right image frame difference value; and
a rendering unit configured to render the synchronized left and right image frames.

12. The apparatus of claim 11, further comprising:
a scene change tine point detecting unit configured to detect a scene change point in time with respect to a left image and a right image.

13. The apparatus of claim 12, wherein the scene change time point detecting unit detects a scene change point in time by using a change in any one of brightness, color, and complexity of preceding and subsequent frames.

14. The apparatus of claim 11, wherein the similarity calculating unit measures similarity by using any one of brightness, color, and complexity of the left image frame and the right image frame related to a scene change point in time.

15. The apparatus of claim 11, wherein the similarity calculating unit measures similarity between preceding or subsequent frames of a plurality of scene change points in time of the left image and the right image.

16. The apparatus of claim 11, wherein the similarity calculating unit measures similarity between a plurality of frames with respect to a plurality of scene change points in time detected for a predetermined time in order to increase accuracy of similarity calculation.

17. The apparatus of claim 11, wherein the left and right image frame difference value extracting unit comprises:
a stereoscopic pair determining unit configured to compare similarity between the left image frame and the right image frame related to the scene to change point in time to determine a stereoscopic pair; and
a difference value calculating unit configured to calculate a temporal frame difference value between a left image frame and a right image frame determined as the stereoscopic pair.

18. A method for compensating for synchronization between left and right images to render left and right images in a stereoscopic system, the method comprising:
a reception operation of receiving a bit stream;
a demultiplexing operation of demultiplexing the received bit stream to generate left and right image frames;
a similarity calculation operation of calculating similarity of the left and right image frames on the basis of a scene change point in time of the generated left and right image frames;
a left and right image frame difference value extraction operation of searching a stereoscopic pair on the basis of the similarity and extracting a temporal frame difference value between the left and right image frames;
a left and right image frame synchronization compensation operation of performing synchronization by shifting one of left and right images in a time axis on the basis of the left and right image frame difference value; and
a rendering operation of rendering the synchronized left and right image frames.
